(19) United States
(12) Patent Application Publication
(10) Pub. No.: US 2018/0046950 A1
(43) Pub. Date: Feb. 15, 2018

(54) TIME-SERIES-DATA PROCESSING DEVICE

(71) Applicant: MITSUBISHI ELECTRIC CORPORATION, Tokyo (JP)

(72) Inventors: Makoto IMAMURA, Tokyo (JP); Takaaki NAKAMURA, Tokyo (JP)

(73) Assignee: MITSUBISHI ELECTRIC CORPORATION, Tokyo (JP)

(21) Appl. No.: 15/550,220

(22) PCT Filed: Jul. 28, 2015
(86) PCT No.: PCT/JP2015/071368

§ 371 Date: Aug. 10, 2017

(51) Int. Cl. G06Q 10/06; G06Q 50/10; G06F 17/18

(52) U.S. Cl. CPC G06Q 10/063; G06F 17/18; G06Q 50/10

(57) ABSTRACT

A leg vibration sequence determinator and a database recorder are provided. The leg vibration sequence determinator determines a leg vibration sequence in the time-series-data and calculates a vibration number and a window size, the leg vibration sequence being a leg series in which the upward leg and the downward leg alternately appear, the vibration number being a number of the legs forming the leg vibration sequence, the window size indicating a range from a start time point to an end time point of the leg vibration sequence. The database recorder records, as leg vibration data in a database, a set of an observation time at the start time point of the leg vibration sequence determined by the leg vibration sequence determinator, amplitude of the legs in the leg vibration sequence, and the vibration number and the window size calculated by the leg vibration sequence determinator.

### TECHNICAL FIELD

The present invention relates to a time-series-data processing device that obtains, for example, sensor values of a control system in a plant, a building, a factory, etc., stock prices at a stock market, company's sales, etc., as observed values that momentarily change, and analyzes time-series-data in which the observed values at the respective times are arranged.

### BACKGROUND ART

Control systems to control plant processes are introduced in, for example, thermal, hydroelectric, and nuclear power plants, etc., chemical plants, steel plants, and water and sewage plants. In addition, control systems to control air conditioning, electricity, lighting, water supply and drainage, etc., are introduced in equipment in buildings, factories, etc.

Those control systems may have a function of accumulating time-series-data in which the observed values at the respective times are arranged. The accumulation is performed by obtaining, at every certain period of time, observed values being sensor values of sensors mounted on various types of devices.

In addition, an information system that handles stock prices at a stock market, company's sales, etc., may also have a function of accumulating time-series-data in which the observed values at the respective times are arranged, where the accumulation is performed by obtaining, at every certain period of time, observed values such as stock prices or sales.

In order that a time-series-data processing device for analyzing time-series-data accumulated in a control system or an information system may detect abnormalities in plant equipment, abnormalities in company management, etc., the accumulated time-series-data is analyzed to detect fluctuation such as upward and downward in observed values.

For example, observed values, such as stock prices, constantly fluctuate up and down. There may be part where observed values slightly fluctuate up and down in part. However, taking a global view of observed values, there may be part where observed values indicating an upward trend are arranged (hereinafter, referred to as an “upward leg”) and part where observed values indicating a downward trend are arranged (hereinafter, referred to as a “downward leg”).

For an index for detecting abnormalities in plant equipment, abnormalities in company management, etc., an upward leg and a downward leg are considered as being more accurate than the parts where observed values slightly fluctuate up and down in part. Therefore, in the time-series-data processing device, upward legs and downward legs are extracted from the accumulated time-series-data.

A leg retrieval technique for extracting upward legs and downward legs from accumulated time-series-data is disclosed in, for example, the following Non-Patent Literature 1.

### CITATION LIST

### Non-Patent Literature 1

Fink, E. and Kevin B. P.: Indexing of Compressed Time-series-data MINING IN TIME-SERIES-DATABASES, World Scientific, pp. 43-65 (2004)

### SUMMARY OF INVENTION

The conventional time-series-data processing device is configured in the above-described manner. Thus, it is capable of extracting an upward leg and a downward leg from time-series-data. The upward leg is partial time series in which observed values indicating an upward trend with time passage are arranged. The downward leg is partial time series in which observed values indicating a downward trend with time passage are arranged. In order to detect abnormalities in plant equipment, abnormalities in company management, etc., a leg vibration sequence being a leg series in which an upward leg and a downward leg alternately appear is a more important index than simple upward and downward legs. However, means for determining a leg vibration sequence is not provided. Therefore, there is a problem that a leg vibration sequence serving as an important index cannot be identified.

As abnormalities in plant equipment, for example, a rattling phenomenon, a hunting phenomenon, etc., of the equipment may be detected. However, even if upward legs and downward legs are simply extracted, it is difficult to accurately grasp the vibration status of observed values. Thus, it is hard to easily detect the rattling phenomenon, the hunting phenomenon, etc., of the equipment.

On the other hand, since a leg vibration sequence is a leg series in which an upward leg and a downward leg alternately appear, it is easy to grasp the vibration status of observed values. Hence, the leg vibration sequence is an important index in terms of detecting the rattling phenomenon, the hunting phenomenon, etc., of the equipment.

The present invention is made to solve a problem such as that described above. An object of the invention is to obtain a time-series-data processing device that is capable of accumulating leg vibration data being information on a leg vibration sequence in which an upward leg and a downward leg alternately appear.

A time-series-data processing device according to the invention is provided with: a leg extractor to extract an upward leg and a downward leg from time-series-data in which observed values at respective times are arranged, the upward leg being partial time series in which observed values indicating an upward trend with time passage are arranged, the downward leg being partial time series in which observed values indicating a downward trend with time passage are arranged; a leg vibration sequence determinator to determine a leg vibration sequence in the time-series-data and calculate a vibration number and a window size, the leg vibration sequence being a leg series in which the upward leg and the downward leg extracted by the leg extractor alternately appear, the vibration number being a number of the legs forming the leg vibration sequence, the window size indicating a range from a start time point to an end time point of the leg vibration sequence; a database recorder to record, as leg vibration data in a database, a set of an observation time at the start time point of the leg vibration sequence determined by the leg vibration sequence determinator, amplitude of the legs in the leg vibration sequence, and the vibration number and the window size calculated by the leg vibration sequence determinator; and a leg vibration data retriever to retrieve leg vibration data satisfying a retrieval condition from the leg vibration data recorded in the database.

According to the invention, it is configured to provide: the leg vibration sequence determinator to determine a leg vibration sequence in the time-series-data and calculate a vibration number and a window size, the leg vibration sequence being a leg series in which the upward leg and the downward leg extracted by the leg extractor alternately appear, the vibration number being a number of the legs forming the leg vibration sequence, the window size indicating a range from a start time point to an end time point of the leg vibration sequence; and the database recorder to record, as leg vibration data in a database, a set of an observation time at the start time point of the leg vibration sequence determined by the leg vibration sequence determinator, amplitude of the legs in the leg vibration sequence, and the vibration number and the window size calculated by the leg vibration sequence determinator. Thus, there is an advantageous effect being capable of accumulating leg vibration data being information about a leg vibration sequence in which an upward leg and a downward leg alternately appear.

### BRIEF DESCRIPTION OF DRAWINGS

FIG. 1 is a structural diagram illustrating a time-series-data processing device of Embodiment 1 of the invention.

FIG. 2 is a hardware structural diagram illustrating the time-series-data processing device of the Embodiment 1 of the invention.

FIG. 3 is a hardware structural diagram for a case in which the time-series-data processing device is realized by a computer.

FIG. 4 is a flowchart representing the processing content of the time-series-data processing device of the Embodiment 1 of the invention.

FIGS. 5A and 5B are illustrative diagrams illustrating examples of time-series-data collected by a time-series-data collector 1 and partial sequence which is part of the time-series-data.

FIGS. 6A and 6B are illustrative diagrams illustrating examples of legs extracted by a leg extractor 2.

FIGS. 7A to 7C are illustrative diagrams illustrating leg vibration sequences and vibration numbers.

FIGS. 8A and 8B are illustrative diagrams illustrating examples of time-series-data collected by the time-series-data collector 1 and leg vibration data (an observation time at a start time point of a leg vibration sequence and the amplitude, vibration number, and window size of the leg vibration sequence) stored in a database 5.

FIGS. 9A and 9B are illustrative diagrams illustrating examples of a retrieval style of leg vibration data by a leg vibration data retriever 9 and retrieval results.

FIG. 10 is an illustrative diagram illustrating example visualization, by a visualizer 10, of retrieval results obtained by the leg vibration data retriever 9.

FIGS. 11A and 11B are illustrative diagrams illustrating sample codes for algorithms (GetLongestLegSeq) for extracting a leg vibration sequence s.

FIG. 12 is an illustrative diagram illustrating a sample code for an algorithm (GetMLV) for obtaining leg vibration data with the smallest window size with respect to amplitude.

FIG. 13 is a structural diagram illustrating a time-series-data processing device of Embodiment 2 of the invention.

FIG. 14 is a flowchart representing the processing content of the time-series-data processing device of the Embodiment 2 of the invention.

FIGS. 15A and 15B are illustrative diagrams illustrating a process of extracting necessary leg vibration data performed by a maximum amplitude leg extractor 11 in a leg vibration data extractor 6.

FIG. 16 is an illustrative diagram illustrating example of visualization of retrieval results obtained by the leg vibration data retriever 9, which is performed by the visualizer 10.

### DESCRIPTION OF EMBODIMENTS

In order to describe the invention in more detail, embodiments for carrying out the invention will be described below with reference to the accompanying drawings.

### Embodiment 1

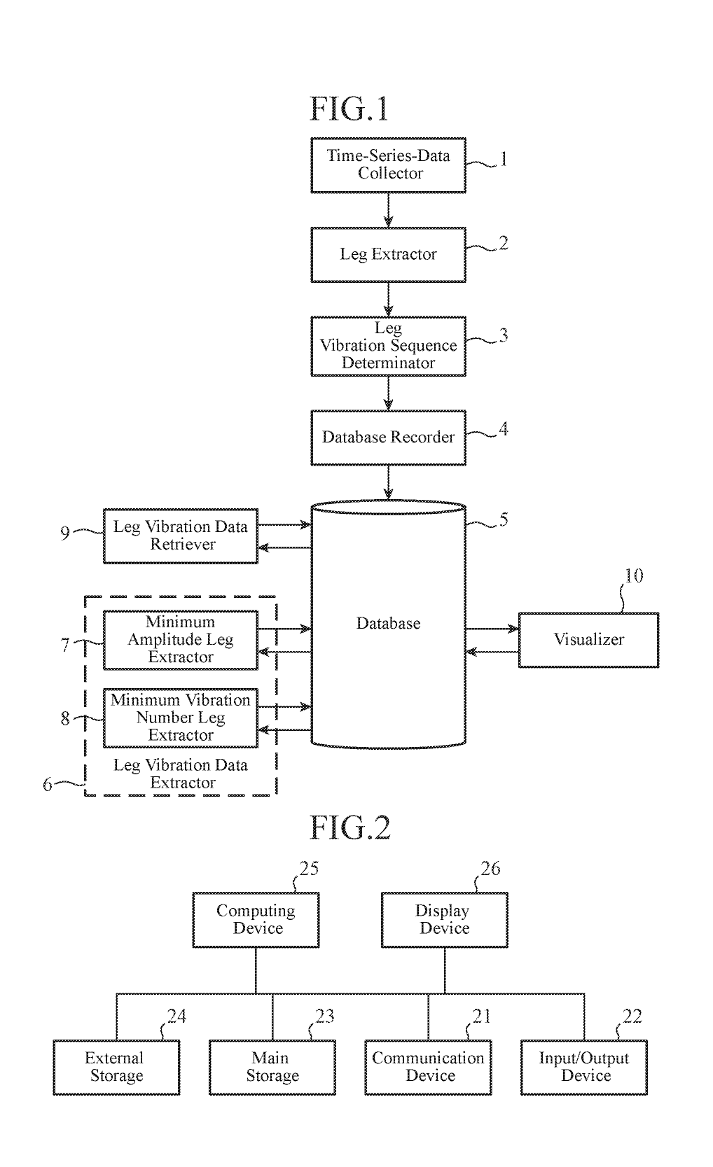

FIG. 1 is a structural diagram illustrating a time-series-data processing device of Embodiment 1 of the invention. FIG. 2 is a hardware structural diagram illustrating the time-series-data processing device of the Embodiment 1 of the invention.

In FIGS. 1 and 2, a time-series-data collector 1 is implemented by, for example, a communication device 21 to receive data transmitted from an external source, or an input/output device 22 including an input/output port such as a USB port. The time-series-data collector 1 performs a process of collecting time-series-data in which observed values at respective times being observed by a control system, an information system, etc., are arranged.

The time-series-data collected by the time-series-data collector 1 is stored in, for example, a main storage 23 or an external storage 24, which is realized by a RAM or a hard disk, respectively.

A leg extractor 2 is implemented by a computing device 25 realized by a semiconductor integrated circuit having, for example, a CPU (Central Processing Unit), a one-chip microcomputer, or the like. The leg extractor 2 performs a process of extracting, from the time-series-data stored in the main storage 23 or the external storage 24, an upward leg being partial time series in which observed values indicating an upward trend with time passage are arranged and a downward leg being partial time series in which observed values indicating a downward trend with time passage are arranged.

Here, the partial time series in which observed values indicating an upward trend with time passage are arranged refers to partial time series in which observed values are arranged, which indicate an upward trend in a global view of observed values while slightly fluctuating up and down in part.

Similarly, the partial time series in which observed values indicating a downward trend with time passage are arranged refers to partial time series in which observed values are arranged, which indicate a downward trend in a global view of observed values while slightly fluctuating up and down in part.

A leg vibration sequence determinator 3 is implemented by, for example, the computing device 25. The leg vibration sequence determinator 3 performs, on the time-series-data stored in the main storage 23 or the external storage 24, a process of determining a leg vibration sequence being a leg series in which the upward leg and downward leg extracted by the leg extractor 2 alternately appear, and calculates a vibration number being the number of legs forming the leg vibration sequence and a window size being a range from a start time point to an end time point of the leg vibration sequence.

A database recorder 4 is implemented by, for example, the computing device 25. The database recorder 4 records, as leg vibration data in a table LV of a database 5, a set of an observation time at the start time point of the leg vibration sequence determined by the leg vibration sequence determinator 3, the amplitude of the legs in the leg vibration sequence, and the vibration number and the window size calculated by the leg vibration sequence determinator 3.

The database 5 is implemented by the main storage 23 or the external storage 24. The database 5 stores, as leg vibration data in the table LV, the set of the observation time at the start time point of the leg vibration sequence, the amplitude of the legs, the vibration number, and the window size.

A leg vibration data extractor 6 is composed of a minimum amplitude leg extractor 7 and a minimum vibration number leg extractor 8. The leg vibration data extractor 6 performs a process of extracting necessary leg vibration data from among the leg vibration data recorded in the database 5.

The minimum amplitude leg extractor 7 is implemented by, for example, the computing device 25. The minimum amplitude leg extractor 7 groups, into amplitude values, pieces of leg vibration data having the same vibration number among the leg vibration data recorded in the table LV of the database 5.

In addition, the minimum amplitude leg extractor 7 compares, for each group, respective window sizes of pieces of leg vibration data belonging to the corresponding group, and extract any one piece of leg vibration data from among the pieces of leg vibration data belonging to the corresponding group. The minimum amplitude leg extractor 7 records the extracted leg vibration data in a table MLV of the database 5.

For example, respective window sizes of one or more pieces of leg vibration data belonging to the corresponding group, that is, one or more pieces of leg vibration data having the same amplitude, are compared. A piece of leg vibration data with the smallest window size is extracted from the one or more pieces of leg vibration data, and the extracted piece of leg vibration data is recorded in the table MLV of the database 5.

The minimum vibration number leg extractor 8 is implemented by, for example, the computing device 25. The minimum vibration number leg extractor 8 groups pieces of leg vibration data into vibration numbers among the leg vibration data recorded in the table LV in the database 5, where the grouped pieces have the same amplitude.

In addition, the minimum vibration number leg extractor 8 compares, for each group, respective window sizes of pieces of leg vibration data belonging to the corresponding group, and extracts any one piece of leg vibration data from the leg vibration data belonging to the corresponding group. The minimum vibration number leg extractor 8 records, in the table MLV of the database 5, the extracted piece of leg vibration data.

For example, respective window sizes of one or more pieces of leg vibration data belonging to the corresponding group, that is, one or more pieces of leg vibration data having the same vibration number, are compared. A piece of leg vibration data with the smallest window size is extracted from the one or more pieces of leg vibration data, and the extracted piece of leg vibration data is recorded in the table MLV of the database 5.

A leg vibration data retriever 9 is implemented by, for example, the computing device 25. The leg vibration data retriever 9 retrieves leg vibration data satisfying a retrieval condition from the leg vibration data recorded in the table MLV of the database 5.

In addition, the leg vibration data retriever 9 calculates a total number of appearances being the number of pieces of leg vibration data which have the same amplitude, the same vibration number, and the same window size among the leg vibration data satisfying the retrieval condition.

A visualizer 10 is implemented by, for example, a display device 26 realized by a GPU (Graphics Processing Unit), a liquid crystal display, etc. The visualizer 10 displays amplitude, window sizes, and total numbers of appearances of the leg vibration data retrieved by the leg vibration data retriever 9 on a three-dimensional graph having the first axis for amplitude, the second axis for window size, and the third axis for the total number of appearances.

In the example of FIG. 1, it is assumed that the time-series-data collector 1, the leg extractor 2, the leg vibration sequence determinator 3, the database recorder 4, the database 5, the leg vibration data extractor 6, the leg vibration data retriever 9, and the visualizer 10, each of which is a component of the time-series-data processing device, are realized by dedicated hardware. Alternatively, the time-series-data processing device may be realized by a computer.

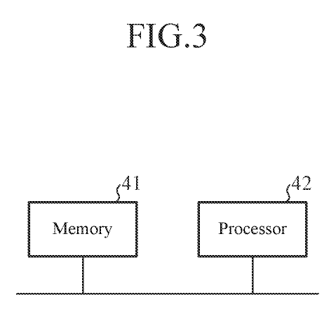

FIG. 3 is a hardware structural diagram for a case in which the time-series-data processing device is realized by a computer.

When the time-series-data processing device is realized by a computer, the database 5 may be formed in a memory 41 of the computer, and a program that describes processing contents of the time-series-data collector 1, the leg extractor 2, the leg vibration sequence determinator 3, the database recorder 4, the leg vibration data extractor 6, the leg vibration data retriever 9, and the visualizer 10 may be stored in the memory 41 of the computer. In this case, a processor 42 of the computer may execute the program stored in the memory 41.

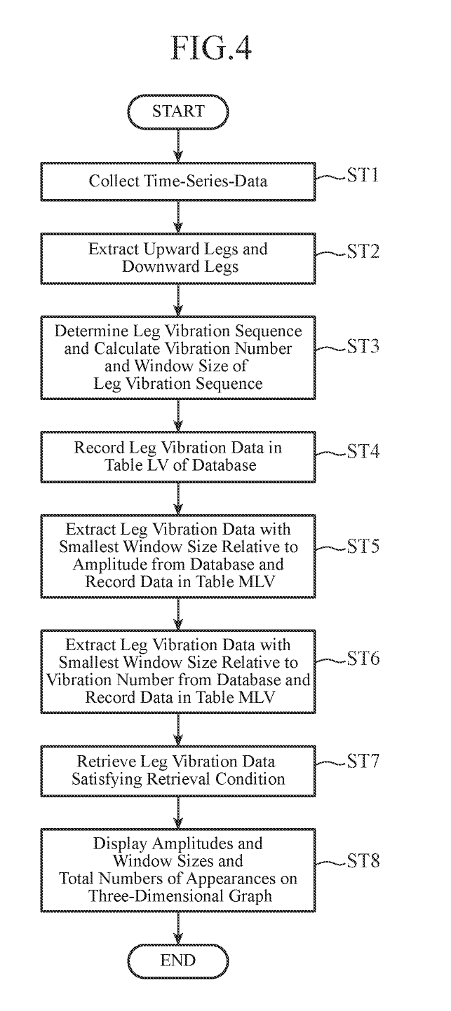

FIG. 4 is a flowchart representing the processing contents of the time-series-data processing device of the Embodiment 1 of the invention.

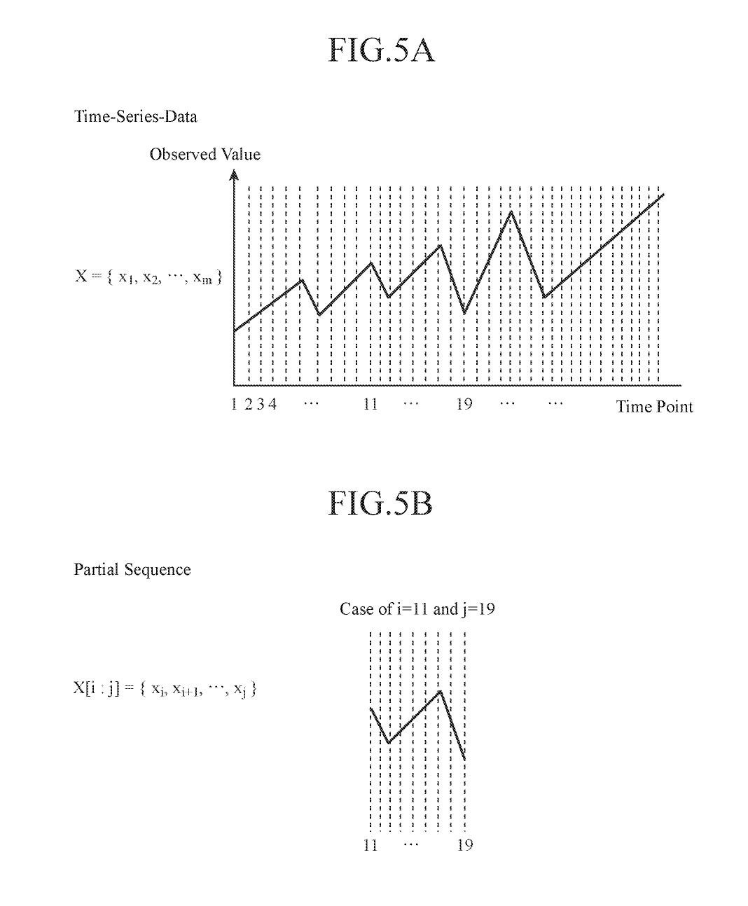

FIGS. 5A and 5B are illustrative diagrams illustrating examples of time-series-data collected by the time-series-data collector 1 and partial sequence (partial time series) which is part of the time-series-data.

Time-series-data X is an ordered list {x₁, x₂, . . . , xₘ} in which m observed values are arranged in the order of observation time. An i-th observed value xᵢ of the time-series-data X is hereinafter denoted as X[i].

The subscript “i” indicates an integer satisfying 1≦i≦m and is called as a “time point”. In addition, “m” is the number of pieces of data on the observed values included in the time-series-data X, and the length of the time-series-data X in which the m observed values are arranged is represented by a length(m).

In FIG. 5A, a vertical axis represents observed values X[i] forming the time-series-data X, and a horizontal axis represents time points i of the observed value X[i].

A list X[i:j]={xᵢ, xᵢ₊ᵢ, . . . , xⱼ} obtained by extracting an i-th observed value X[i] to a j-th observed value X[j] of the time-series-data X is referred to as partial sequence of the time-series-data X.

In addition, a start time point p of the partial sequence X[i:j] is represented as start(X[i:j]), and an end time point q of the partial sequence X[i:j] is represented as end(X[i:j]).

The length of the partial sequence X[i:j] is j−i+1. The length of the partial sequence indicates a range from the start time point to the end time point of the partial sequence, and is hereinafter referred to as a “window size”.

FIG. 5B shows partial sequence for a case of i=11 and j=19 in the time-series-data shown in FIG. 5A.

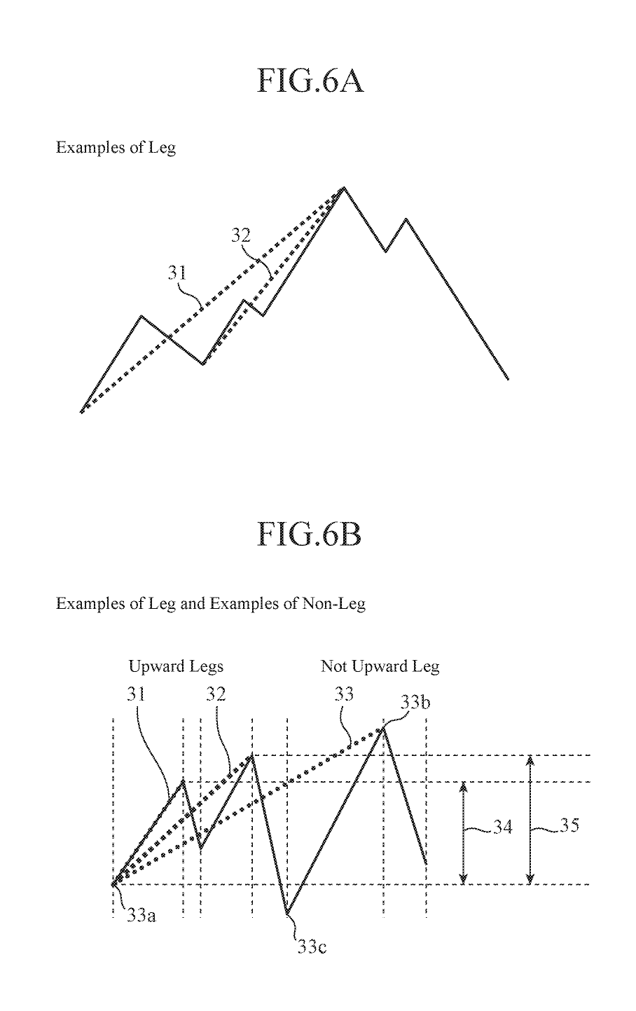

FIGS. 6A and 6B are illustrative diagrams illustrating examples of legs extracted by the leg extractor 2.

FIG. 6A shows examples of a leg, and FIG. 6B shows examples of a leg and examples of a non-leg.

The leg refers to partial sequence that goes upward or downward in a global view while slightly fluctuating up and down in part.

In the case of an upward leg, an observed value at the end time point of partial sequence is larger than an observed value at the start time point of the partial sequence. In this case, all observed values from the start time point to the end time point are greater than or equal to the observed value at the start time point of the partial sequence, and also are less than or equal to the observed value at the end time point of the partial sequence.

On the other hand, in the case of a downward leg, an observed value at the end time point of partial sequence is smaller than an observed value at the start time point of the partial sequence. In this case, all observed values from the start time point to the end time point are less than or equal to the observed value at the start time point of the partial sequence, and also are greater than or equal to the observed value at the end time point of the partial sequence.

In the examples of FIGS. 6A and 6B, 31 and 32 are upward legs because they indicate partial sequences that globally go upward.

On the other hand, in partial sequence 33, while an observed value 33b at an end time point is larger than an observed value 33a at a start time point, an observed value 33c between the start time point and the end time point is smaller than the observed value 33a at the start time point. Therefore, the partial sequence 33 is not an upward leg.

Legs are formally defined below.

### [Monotonic Leg]

For example, when X[p:q] being partial sequence satisfies either the following conditional formula (1) or (2), the partial sequence X[p:q] is referred to as a monotonic leg.

For all “i” that satisfy p+1≦i≦q−1: X[i−1]<X[i]<X[i+1] Conditional formula (1)

For all “i” that satisfy p+1≦i≦q−1: X[i−1]>X[i]>X[i+1] Conditional formula (2)

### [Leg]

For example, when X[p:q] being partial sequence satisfies either the following conditional formula (3) or (4), the partial sequence X[p:q] is referred to as a leg. Particularly, when the conditional formula (3) is satisfied, the partial sequence X[p:q] is referred to as an upward leg. When the conditional formula (4) is satisfied, the partial sequence X[p:q] is referred to as a downward leg.

For all “i” that satisfy p≦i≦q:X[p]≦X[i]≦X[q] Conditional formula (3)

For all “i” that satisfy p≦i≦q:X[p]≧X[i]≧X[q] Conditional formula (4)

The upward leg is not partial sequence like the monotonic leg in which the observed values X[i] always monotonously go upward from the start time point p to end time point q of the partial sequence X[p:q]. The upward leg is partial sequence in which all observed values X[i] between the start time point p and end time point q have values greater than or equal to the observed value X[p] at the start time point p and also have values less than or equal to the observed value X[q] at the end time point q.

In addition, the downward leg is not partial sequence like the monotonic leg in which the observed values X[i] always monotonously go downward from the start time point p to end time point q of the partial sequence X[p:q]. The downward leg is partial sequence in which all observed values X[i] from the start time point p to the end time point q have values less than or equal to the observed value X[p] at the start time point p and also have values greater than or equal to the observed value X[q] at the end time point q.

### [Maximum Leg]

For example, when X[p:q] being partial sequence is an upward leg and satisfies the following conditional formulas (5) to (8), the partial sequence X[p:q] is referred to as a maximum upward leg:

For all “i” that satisfy p<i≦q:X[p]<X[i] Conditional formula (5)

For all “i” that satisfy p≦i<q:X[i]<X[q] Conditional formula (6)

X[p−1]≧X[p] Conditional formula (7)

X[q]≧X[q+1] Conditional formula (8)

Note that, when X[p−1] or X[q+1] is not present, the conditional formula (7) or (8) is not included in the conditions.

Further, for example, when X[p:q] being partial sequence is a downward leg and satisfies the following conditional formulas (9) to (12), the partial sequence X[p:q] is referred to as a maximum downward leg.

For all “i” that satisfy p<i≦q:X[p]>X[i] Conditional formula (9)

For all “i” that satisfy p≦i<q:X[i]>X[q] Conditional formula (10)

X[p−1]≦X[p] Conditional formula (11)

X[q]≦X[q+1] Conditional formula (12)

Note that, when X[p−1] or X[q+1] is not present, the conditional formula (11) or (12) is not included in the conditions.

When the partial sequence X[p:q] is a leg, the amplitude of the leg amp(X[p:q]) is represented by the following formula (13).

amp(X[p:q])=abs(X[q]−X[p]) (13)

In formula (13), abs(A) is a function that returns the absolute value of A.

The sign of the leg sign(X[p:q]) is represented by the following formula (14). When the sign is positive, the leg is an upward leg. When the sign is negative, the leg is a downward leg.

sign(X[p:q])=sign(X[q]−X[p]) (14)

In the formula (14), sign(A) is a function that returns the sign of A.

In FIG. 6B, 34 indicates the amplitude of the upward leg 31, and 35 indicates the amplitude of the upward leg 32.

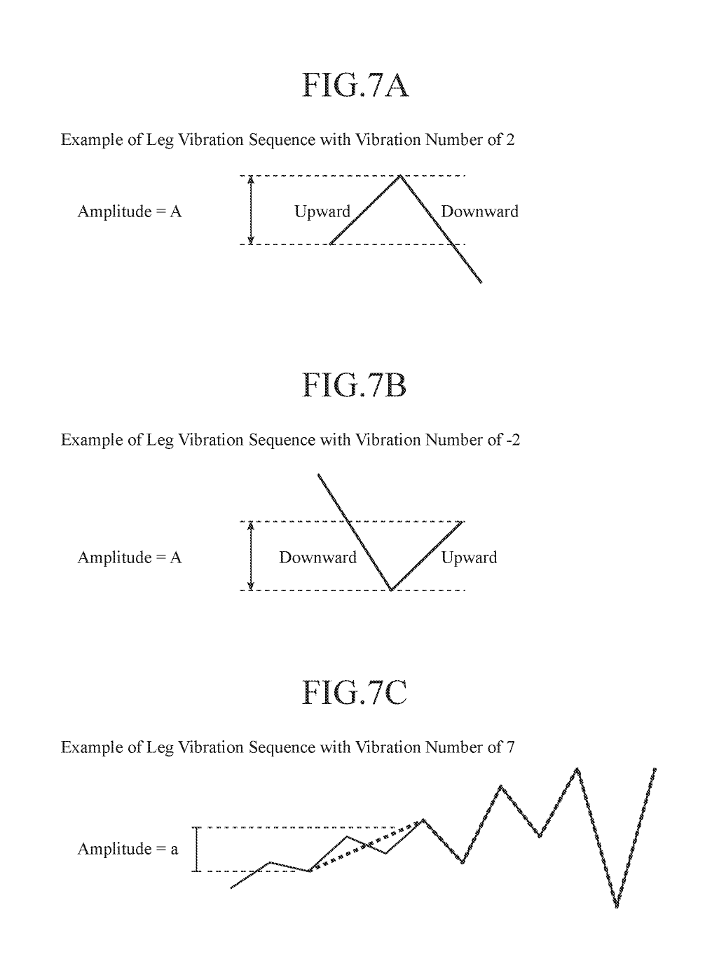

FIGS. 7A to 7C are illustrative diagrams illustrating leg vibration sequences and vibration numbers.

FIG. 7A illustrates an example of a leg vibration sequence in which a downward leg appears subsequent to an upward leg. The vibration number of this case is 2.

FIG. 7B illustrates an example of a leg vibration sequence in which in which an upward leg appears subsequent to a downward leg. The vibration number of this case is −2.

FIG. 7C illustrates an example of a leg vibration sequence in which an upward leg, a downward leg, an upward leg, a downward leg, an upward leg, a downward leg, and an upward leg appear in this order. The vibration number of this case is 7.

The leg vibration sequence and the vibration number are defined below.

### [Leg Vibration Sequence]

For example, when the following conditional formulas (15) to (17) are satisfied with X₁, X₂, . . . , Xₙ being maximum legs, a leg series s=[X₁, X₂, . . . , Xₙ] is referred to as a leg vibration sequence with the amplitude a. In addition, the number of legs forming the leg vibration sequence is represented as a length(s). The “a” is a positive real number.

For all “i” that satisfy 1≦i≦n−1:end(Xᵢ)≦start(Xᵢ₊₁) Conditional formula (15)

amp(Xᵢ)≧a Conditional formula (16)

amp(Xᵢ)·amp(Xᵢ₊₁)<0 Conditional formula (17)

In the leg vibration sequence, partial sequence whose amplitude sign is plus (+) and partial sequence whose amplitude sign is minus (−) are alternately arranged, and the absolute values of the amplitude of the partial sequences are greater than or equal to a.

Here, with regard to the leg vibration sequence, “sign” as the sign, “start” as the start time point, “end” as the end time point, and “last” as the last leg are defined by the following formulas (18) to (21) using the first leg X₁ of the leg vibration sequence and the last leg Xₙ of the leg vibration sequence.

sign(s)=sign(X₁) (18)

start(s)=start(X₁) (19)

end(s)=end(Xₙ) (20)

last(s)=Xₙ (21)

### [Leg Vibration Sequence Set]

For example, when the time-series-data is X, the amplitude is greater than or equal to a, the window size is w, and the time point is t, a set of leg vibration sequences s with the amplitude a, which satisfies the following conditional formulas (22) and (23) or more, is referred to as a leg vibration sequence set S(X, a, w, t).

t≦start(s) Conditional formula (22)

end(s)≦t+w−1 Conditional formula (23)

As preparation for defining the leg vibration number, the following lemma concerning the signs of leg vibration sequences having the longest length is proved.

### [Lemma: Identicalness of the Signs of Longest-Leg Vibration Sequences]

In a leg vibration sequence set S(X, a, w, t), leg vibration sequences having the longest length have the same sign.

### [Proof]

It is assumed that a leg vibration sequence s=[Xₛ₁, Xₛ₂, . . . , Xₛₙ] and a leg vibration sequence u=[Xᵤ₁, Xᵤ₂, . . . , Xᵤₙ] are leg vibration sequences, each of which has the longest length, and the leg vibration sequence s and the leg vibration sequence u are leg vibration sequences having different signs from each other.

It is proved hereafter that the above assumption is contradictory. Here, for convenience sake, the explanation is made with a condition that the sign of the leg vibration sequence s is positive and the sign of the leg vibration sequence u is negative. Even if the signs are determined in this manner, generality is not lost.

First, it is proved that the temporal interval [start(Xₛ₁, end(Xₛ₁))] of the first leg Xₛ₁ of the leg vibration sequence s does not intersect the temporal interval [start(Xᵤ₁, end(Xᵤ₁))] of the first leg Xᵤ₁ of the leg vibration sequence u.

Assume that start(Xₛ₁)<start(Xᵤ₁)<end(Xₛ₁)<end(Xᵤ₁). In this case, X[start(Xᵤ₁)]<X[end(Xₛ₁)] is satisfied because the leg vibration sequence s has a positive sign and the leg vibration sequence s is a maximum upward leg, and also X[start(Xᵤ₁)]>X[end(Xₛ₁)] is satisfied because the leg vibration sequence u has a negative sign and the leg vibration sequence u is a maximum downward leg. Therefore, there is a contradiction.

Similarly, in a case of start(Xᵤ₁)<start(Xₛ₁)<end(Xᵤ₁)<end(Xₛ₁), there is a contradiction.

Therefore, it is required to be end(Xₛ₁)≦start(Xᵤ₁) or end(Xᵤ₁)≦start(Xₛ₁).

If end(Xₛ₁)≦start(Xᵤ₁), [Xₛ₁, Xᵤ₁, . . . , Xᵤₙ] is a leg vibration sequence with the length n+1. This matter contradicts the assumption that the leg vibration sequence s and the leg vibration sequence u have the longest length.

Furthermore, if end(Xᵤ₁)≦start(Xₛ₁), [Xᵤ₁, Xₛ₁, . . . , Xₛₙ] is a leg vibration sequence with the length n+1. This matter contradicts the assumption that the leg vibration sequence s and the leg vibration sequence u have the longest length.

Hence, it is required that the first leg Xₛ₁ and the first leg Xᵤ₁ have the same sign. By the definition of “sign” as the sign of a leg vibration sequence, the leg vibration sequence s and the leg vibration sequence u have the same sign.

### [Leg Vibration Number]

For example, when a set of leg vibration sequences is S(X, a, w, t), the leg vibration number F_{X,a,w}(t) is defined by the following formula (24).

F_{X,a,w}(t)=sign(lₘₐₓ)×length(lₘₐₓ) (24)

lₘₐₓ=argmax_{lεS(X,a,w,t)}length(l)

Note that “argmax” is a symbol indicating a set of elements of a domain where length(l) is longest. The lₘₐₓ indicates a leg vibration sequence having the longest length among the leg vibration sequence set S(X, a, w, t).

The above-described lemma represents that, even if there are a plurality of leg vibration numbers, each of which has the longest length, sign(lₘₐₓ) is uniquely determined, and thus, the leg vibration number can be defined without contradiction.

The intuitive meaning of the leg vibration number will be described below.

The leg vibration number indicates the quantified behavior of up-and-down vibrations in partial sequence with the window size w which starts at the time point t. It means that the larger the absolute value of the leg vibration number, the higher the frequency of vibration, and also means that the larger the amplitude a, the larger the amplitude of vibration.

In addition, in a case of a leg vibration number having a positive sign, it indicates that vibrations start with an upward vibration. In a case of a leg vibration number having a negative sign, it indicates that vibrations start with a downward vibration.

For example, in a case of a leg vibration number of 1, it corresponds to an upward leg disclosed in the above-described Non-Patent Literature 1, and in a case of a leg vibration number of −1, it corresponds to a downward leg disclosed in the above-described Non-Patent Literature 1.

In a case of a leg vibration number of 2, it indicates that partial sequence with the window size w that starts at the time point t has a convex peak shape. This is because the first leg is a leg that goes upward with the amplitude “a” or more, and also a leg following the first leg is a leg that goes downward with the amplitude “a” or more.

In a case of a leg vibration number of −2, it indicates that partial sequence with the window size w that starts at the time point t has concave up-and-down vibrations. This is because the first leg is a leg that goes downward with the amplitude “a” or more and a leg following the first leg is a leg that goes upward with the amplitude “a” or more. As a rule for detecting abnormalities in equipment, a condition for detecting a peak with amplitude having a certain value or more, specifically, a condition that a convex peak shape or concave up-and-down vibrations are present, is used in many cases. Therefore, detection of partial sequence with a leg vibration number of 2 or −2 is useful in terms of detecting abnormalities in equipment.

In a case of a leg vibration number of 4, it indicates a pattern where an upward leg, a downward leg, an upward leg, and a downward leg with the amplitude “a” or more appear in turn. A condition that the absolute value of the leg vibration number is four or more is often used as a rule for detecting abnormalities in equipment. Therefore, detection of partial sequence with a leg vibration number of 4 is also useful in terms of detecting abnormalities in equipment.

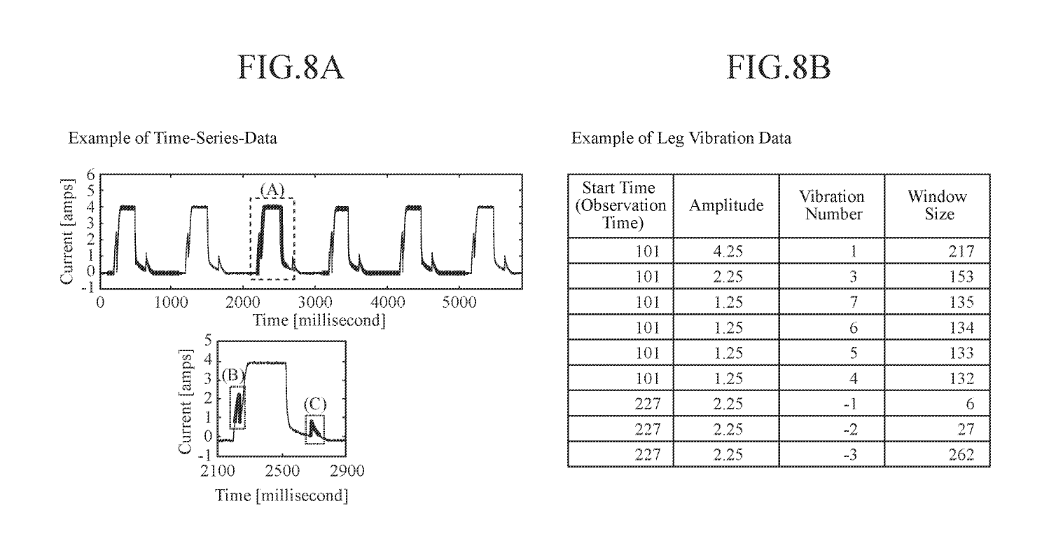

FIGS. 8A and 8B are illustrative diagrams illustrating examples of time-series-data collected by the time-series-data collector 1 and leg vibration data (the observation time at a start time point, leg amplitude, vibration number, and window size of a leg vibration sequence) stored in the database 5.

The time-series-data of FIG. 8A is space shuttle Marotta valve data which is disclosed in the following Non-Patent Literature 2.

### Non-Patent Literature 2

Keogh, E., Zhu, Q., Hu, B., Hao. Y., Xi, X., Wei, L. & Ratanamahatana, C. A. (2011). The UCR Time Series Classification/Clustering Homepage

The sampling cycle of time-series-data in FIG. 8A is one millisecond, and the unit is ampere.

In this time-series-data, there is a large convex-shaped pattern ((A) surrounded by a dotted-line box in the drawing) having amplitude on the order of 4 and a number of time points on the order of 400.

In addition, there is an upward and downward pattern ((B) surrounded by a dotted-line box in the drawing) having amplitude on the order of 1.5 to 2 and a number of time points on the order of 30 to 50. Further, there is a convex-shaped pattern ((C) surrounded by a dotted-line box in the drawing) having amplitude on the order of 1 and a number of time points on the order of 50, which is appearing subsequent to the large convex-shaped pattern.

For example, in detection of abnormalities in observed values which are sensor values of a control system, it is important to extract normally present patterns such as (A) to (C) and compare respective shapes of the patterns with each other. Hence, retrieval of time-series-data using the leg amplitude, vibration number, and window size as retrieval conditions is important in terms of application.

FIG. 8B shows an example of leg vibration data stored in the database 5, and the leg vibration data is represented in table format. Namely, the leg vibration data is recorded in the table LV.

The leg vibration data consists of the observation time at a start time point (start time), leg amplitude, vibration number, and window size of a leg vibration sequence.

For example, the first line of the table LV indicates that “a window with a length of 217 that starts at a time 101 has an upward leg with the amplitude of 4.25 or more”.

Likewise, the second line of the table LV indicates that “a window with a length of 153 that starts at time 101 has a leg series including an upward leg, a downward leg, and an upward leg with the amplitude of 2.25 or more”.

In addition, the eighth line of the table LV indicates that “a window with a length of 27 that starts at time 227 has a leg series including a downward leg and an upward leg with the amplitude of 2.25 or more”.

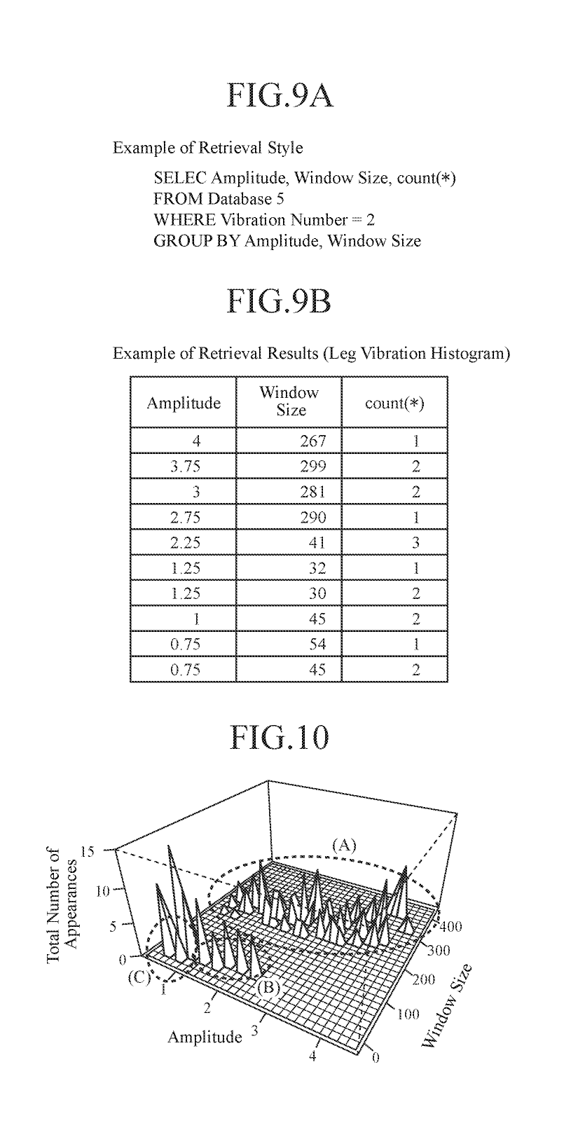

FIGS. 9A and 9B are illustrative diagrams illustrating examples of a retrieval style of leg vibration data by the leg vibration data retriever 9 and retrieval results.

FIG. 9A shows an example of a retrieval style of leg vibration data by the leg vibration data retriever 9.

The syntax and meaning of the retrieval style follow the retrieval language SQL for a relational database which is an existing technique. FIG. 9A shows an example in which a retrieval condition that the vibration number of a leg vibration sequence is 2 (i.e., a convex-shaped pattern) is given, and leg vibration data satisfying the retrieval condition is retrieved from a plurality of pieces of leg vibration data recorded in the database 5.

The retrieval results shown in FIG. 9B represent amplitude and window sizes of pieces of leg vibration data, where the vibration numbers of leg vibration sequences are 2, and also represent the total numbers of appearances count(*).

The total number of appearances count(*) indicates the number of pieces of leg vibration data having the same amplitude, the same vibration number, and the same window size. Computation of the total number of appearances count(*) is performed by the leg vibration data retriever 9, which will be described later.

For example, the first line of the retrieval results shown in FIG. 9B indicates that there is one convex-shaped pattern with the amplitude of 4 or more and the window size of 267.

In addition, the second line indicates that there are two convex-shaped patterns with the amplitude of 3.75 or more and the window size of 299.

FIG. 10 is an illustrative diagram illustrating example visualization, by the visualizer 10, of retrieval results obtained by the leg vibration data retriever 9.

In FIG. 10, an axis extending from the foreground toward the back left (the first axis) represents the leg amplitude, an axis extending from the foreground toward the back right (the second axis) represents the window size of leg vibration data, and an axis that intersects both of the first and second axes (the third axis) represents the total number of appearances count(*) of the leg vibration data.

The amplitude, the window sizes, and the total numbers of appearances of leg vibration data retrieved by the leg vibration data retriever 9 are displayed on a three-dimensional graph having the first to third axes.

The parts (A), (B), and (C) shown in FIG. 10 correspond to the parts (A), (B), and (C) shown in FIG. 8A.

By observing the frequency of convex-shaped patterns with two axes indicating the amplitude and the window size, a state of a distribution of time-series convex-shaped patterns can be viewed at a glance.

Next, operation will be described.

Description will be made below with reference to a flowchart of FIG. 4.

The time-series-data collector 1 collects time-series-data X in which observed values X[i] (1≦i≦m) at respective times observed by a control system, an information system, etc., are arranged (step ST1 in FIG. 4). For example, the time-series-data collector 1 collects time-series-data X, such as that shown in FIG. 5A or FIG. 8A.

The time-series-data X collected by the time-series-data collector 1 is stored in, for example, the main storage 23 or the external storage 24, which is realized by a RAM, a hard disk, etc.

The leg extractor 2 extracts, as an upward leg, partial sequence X[p:q] satisfying the above-described conditional formula (3) from the time-series-data X stored in the main storage 23 or the external storage 24, and also extracts, as a downward leg, partial sequence X[p:q] satisfying the above-described conditional formula (4) from the time-series-data X (step ST2 in FIG. 4).

For example, the leg extractor 2 performs initial setup for a range (a time range) where an upward leg and a downward leg are extracted, on the time-series-data X stored in the main storage 23 or the external storage 24, and extracts upward legs and downward legs from the time-series-data X while sliding the extraction range. Assuming that time-series-data X shown in FIG. 8A is collected, the initial setup is performed for a small extraction range with a time point on the order of 0 to 100, for example. Note that the extraction range for which initial setup is performed is arbitrary.

By extracting upward legs and downward legs from the time-series-data X while sliding the extraction range, the start time points and end time points of the upward legs and downward legs can be easily found. Thus, a process of extracting upward legs and downward legs can be performed rapidly over a case of extracting upward legs and downward legs using the whole time-series-data X as an extraction range.

The example is shown here, in which the leg extractor 2 extracts upward legs and downward legs from the time-series-data X while sliding a range for extracting upward legs and downward legs. The leg retrieval technique for extracting upward legs and downward legs from the time-series-data X is also disclosed in the above-described Non-Patent Literature 1. Upward legs and downward legs may be extracted from the time-series-data X by using the leg retrieval technique disclosed in Non-Patent Literature 1.

After the leg extractor 2 extracts upward legs and downward legs from the time-series-data X, the leg vibration sequence determinator 3 determines, in the time-series-data X, a leg vibration sequence s being a leg series in which an upward leg and a downward leg extracted by the leg extractor 2 alternately appear (step ST3 in FIG. 4).

Specifically, the leg vibration sequence determinator 3 determines a leg vibration sequence s that satisfies the above-described conditional formulas (15) to (17). For example, when the amplitude “a” or more, the window size w, and the time point t are specified, the leg vibration sequence determinator 3 extracts, as the leg vibration sequence s, partial sequence having the longest length among a leg vibration sequence set S(X, a, w t) that satisfies the above-described conditional formulas (22) and (23).

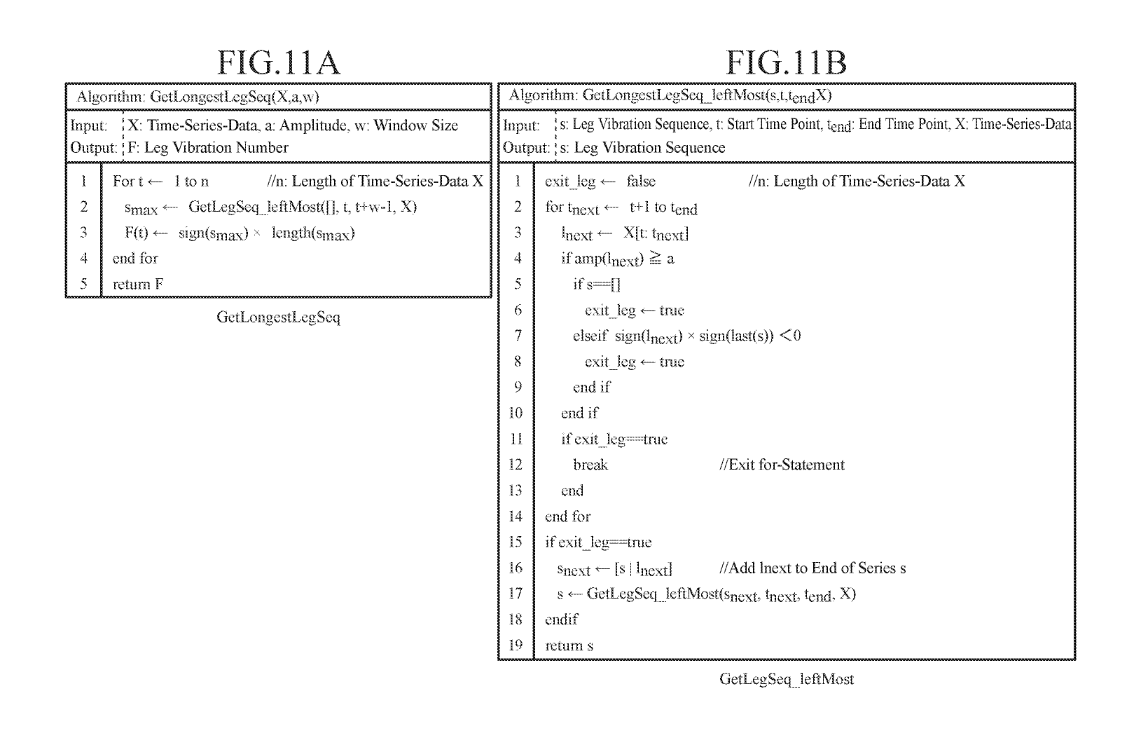

Here, FIGS. 11A and 11B are illustrative diagrams illustrating sample codes for algorithms (GetLongestLegSeq) for extracting a leg vibration sequence s.

The operation of extracting a leg vibration sequence s from a leg vibration sequence set S(X, a, w, t) will be briefly described below.

In the first to fifth lines of the sample code in FIG. 11A, the leg vibration sequence determinator 3 obtains, for each time point t of the time-series-data X, a leg vibration sequence sₘₐₓ and also obtains a leg vibration number F_{X,a,w}(t) of the leg vibration sequence sₘₐₓ.

In the second line of the sample code in FIG. 11A, the leg vibration sequence determinator 3 calls “GetLegSeq_leftMost” shown in FIG. 11B by using a leg vibration sequence [ ] with a length of 0 as an argument, and thereby obtains a leftmost leg vibration sequence sₘₐₓ within a window from a start time point t to an end time point t+w−1. The definition of the leftmost leg vibration sequence will be described later.

After obtaining the leftmost leg vibration sequence sₘₐₓ, the leg vibration sequence determinator 3 obtains, in the third line of the sample code of FIG. 11A, a leg vibration number F_{X,a,w}(t) from the sign “sign(sₘₐₓ)” and length “length(sₘₐₓ)” of the leftmost leg vibration sequence sₘₐₓ.

Next, the operation for “GetLegSeq_leftMost” shown in FIG. 11B will be described.

In the first line of the sample code, the leg vibration sequence determinator 3 assigns “false” to a flag “exit_leg” indicating whether a leftmost leg (the leftmost leg will be described later) is present subsequent to the leg vibration sequence s being an argument.

In the second line of the sample code, the leg vibration sequence determinator 3 assigns time points from t+1 to t_{end} in turn to “tₙₑₓₜ” indicating the next time point. In the third line of the sample code, the leg vibration sequence determinator 3 assigns partial sequence X[t:tₙₑₓₜ] to a subsequent leg candidate indicated by a variable lₙₑₓₜ.

In the fourth to sixth lines of the sample code, if the amplitude amp(lₙₑₓₜ) of the leg candidate lₙₑₓₜ is greater than or equal to a and the leg vibration sequence s is an empty sequence, then the leg vibration sequence determinator 3 assigns “true” to the flag “exit_leg”.

In the fourth, seventh, and eighth lines of the sample code, if the amplitude amp(lₙₑₓₜ) of the leg candidate lₙₑₓₜ is greater than or equal to a and the product of the “sign sign(last(s)) of the last leg last(s) of the leg vibration sequence s” and the “sign sign(lₙₑₓₜ) of the leg candidate lₙₑₓₜ” is negative, the leg candidate lₙₑₓₜ is a leftmost leg. Thus, the leg vibration sequence determinator 3 assigns “true” to the flag “exit_leg”.

In the eleventh to thirteenth lines of the sample code, if the flag “exit_leg” is “true”, the leg vibration sequence determinator 3 exits the for-statement of “GetLegSeq_leftMost” shown in FIG. 11B.

After exiting the for-statement, in the fifteenth to eighteenth lines of the sample code, if the flag “exit_leg” is “true”, the leg vibration sequence determinator 3 adds the leg candidate lₙₑₓₜ to the end of the leg vibration sequence s, assigns to sₙₑₓₜ the leg vibration sequence in which the leg candidate lₙₑₓₜ has been added, recursively calls GetLegSeq_leftMost(sₙₑₓₜ, tₙₑₓₜ, t_{end}, X), and assigns a return value of the call to the leg vibration sequence s.

Finally, in the nineteenth line of the sample code, the leg vibration sequence determinator 3 returns the leg vibration sequence s as sₘₐₓ to “GetLongestLegSeq” shown in FIG. 11A.

The algorithms of FIGS. 11A and 11B obtain a leg vibration sequence (the leftmost leg vibration sequence) obtained by selecting a leg (the leftmost leg) whose end time point is located farthest to the left, that is, selecting a leg having the earliest end time point, in order of different signs. In order to obtain a leg vibration number, the length of the leg vibration sequence needs to be longest. As shown below, it can be proved that the leftmost leg vibration sequence has the longest length in the leg vibration sequence.

### [Leftmost Leg Vibration Sequence]

In a case where time-series-data is X, amplitude is greater than or equal to “a” (a positive real value), the window size is w, and the time point is t, a set of legs each having the amplitude “a” or more, which is present in partial sequence X[t, t+w−1], is indicated as L.

First, a leg having the earliest end time point in the leg set L is set as m₁. Subsequently, a leg having a different amplitude sign than a leg mᵢ and having the earliest end time point among legs present after the leg mᵢ is set as mᵢ₊₁. The leg mᵢ₊₁ is recursively selected as shown in the following formula (25).

mᵢ₊₁=argmax_{1εLi}end(l) (25)

where Lᵢ=def{lεL|
start(1)≧end(mᵢ) and
sign(1)×sign(mᵢ)<0}

A leg series [m₁, m₂, . . . , mₙ] obtained by applying this operation is referred to as a leftmost leg vibration sequence in the partial sequence X[t, t+w−1].

### [Theorem: The Longest Property of a Leftmost Leg Vibration Sequence]

When a leg vibration sequence set is S(X, a, w, t), the leftmost leg vibration sequence in the partial sequence X[t, t+w−1] is a leg vibration sequence having the longest length in S(X, a, w, t).

### [Proof]

It is assumed that the leftmost leg vibration sequence is s=[Xₛ₁, Xₛ₂, . . . , Xₛₙ] and the length of the leftmost leg vibration sequence s is n.

In addition, it is assumed that an arbitrary leg vibration sequence having the longest length is u=[Xᵤ₁, Xᵤ₂, . . . , Xᵤₘ] and the length of the leg vibration sequence u is m.

It is proved here that there is a contradiction when n<m is assumed.

First, it is proved that the leg Xₛ₁ and the leg Xᵤ₁ must have the same sign. Assume that the leg Xₛ₁ and the leg Xᵤ₁ have different signs. In this case, by using the fact that s is the leftmost leg vibration sequence and the same reasoning as that for the above-described lemma, [Xₛ₁, Xᵤ₁, Xᵤ₂, . . . , Xᵤₘ] is a leg vibration sequence with the length m+1. Accordingly, it contradicts the fact that the leg vibration sequence u has the longest length.

Since the leg Xₛ₁ and the leg Xᵤ₁ have the same sign and s is the leftmost leg vibration sequence, end(Xₛ₁)≦end(Xᵤ₁)≦start(Xᵤ₂) is satisfied. Therefore, [Xₛ₁, Xᵤ₂, . . . , Xᵤₘ] is a leg vibration sequence with the length m.

Likewise, since s is the leftmost leg vibration sequence and end(Xₛ₂)≦end(Xᵤ₂)≦start(Xᵤ₃) is satisfied, [Xₛ₁, Xₛ₂, Xᵤ₃, . . . , Xᵤₘ] is a leg vibration sequence with the length m.

If n<m, the above-described operation can be repeated n times, and thus, [Xₛ₁, . . . Xₛₙ, Xᵤₙ₊₁, . . . , Xᵤₘ] becomes a leg vibration sequence. However, in the partial sequence X[end(sn):end(um)], a leftmost leg having the same sign as the leg Xᵤₙ₊₁ ought to be present. Therefore, it contradicts the fact that s is a leftmost leg vibration sequence. Hence, the theorem is proved.

After determining a leg vibration sequence s, the leg vibration sequence determinator 3 calculates a vibration number which is the number of legs forming the leg vibration sequence s, and a window size which is a range from the start time point to end time point of the leg vibration sequence (step ST3 in FIG. 4).

The database recorder 4 records, as leg vibration data in the table LV in the database 5, a set of an observation time at the start time point of the leg vibration sequence determined by the leg vibration sequence determinator 3, the amplitude of legs in the leg vibration sequence, and the vibration number and window size calculated by the leg vibration sequence determinator 3 (step ST4 in FIG. 4).

As a result, as shown in FIG. 8B, the leg vibration data including a set of the observation time at the start time point, leg amplitude, vibration number, and window size of the leg vibration sequence are stored in the table LV of the database 5.

After the database recorder 4 records the leg vibration data in the table LV in the database 5, the leg vibration data extractor 6 performs a process of extracting necessary leg vibration data from the leg vibration data recorded in the table LV of the database 5 because the table LV of the database 5 may include redundant leg vibration data.

Specifically, the minimum amplitude leg extractor 7 in the leg vibration data extractor 6 groups, into amplitude values, pieces of leg vibration data having the same vibration number among the leg vibration data recorded in the table LV of the database 5, and compares, for each group, respective window sizes of pieces of leg vibration data belonging to the group.

Subsequently, the minimum amplitude leg extractor 7 extracts, for each group, leg vibration data with the smallest window size from leg vibration data belonging to the group (one or more pieces of leg vibration data having the same amplitude), and records the extracted leg vibration data in the table MLV of the database 5 (step ST5 in FIG. 4).

The leg vibration data with the smallest window size with respect to amplitude is defined below. Namely, leg vibration data on a minimum leg vibration sequence s with respect to amplitude is defined.

[Leg Vibration Data with the Smallest Window Size with Respect to Amplitude]

Prior to defining the leg vibration data with the smallest window size with respect to amplitude, it is noted that a leg amplitude A_{X,f,w}(t) is defined by the following formula (26), where the time-series-data is X, the leg vibration number is f, the window size is w, the time point is t, and the leg vibration sequence set is S(X, a, w, t).

A_{X,f,w}(t)=max_{sε(X,a,w,t)}amp(s) (26)

It is assumed that when the leg vibration number is f, a leg vibration sequence s satisfying the following formulas (27) and (28) is a minimum leg vibration sequence with respect to amplitude.

A_{X,f,w}(t)>A_{X,f,w-1}(t−1) (27)

A_{X,f,w}(t)>A_{X,f,w-1}(t) (28)

where t=start(s) and w=end(s)−start(s)+1

Accordingly, leg vibration data on the leg vibration sequence s satisfying the formulas (27) and (28) is leg vibration data with the smallest window size with respect to amplitude.

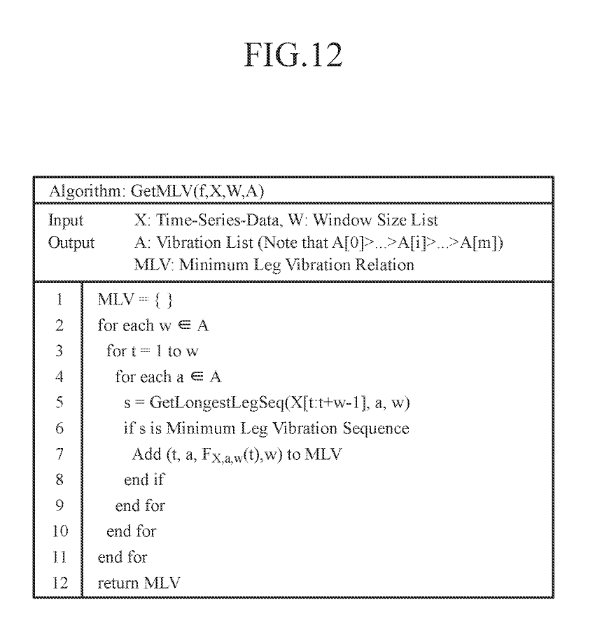

FIG. 12 is an illustrative diagram illustrating a sample code for an algorithm (GetMLV) for obtaining leg vibration data with the smallest window size with respect to amplitude.

The operation of obtaining leg vibration data with the smallest window size with respect to amplitude will be briefly described below.

In the first line of the sample code, the minimum amplitude leg extractor 7 assigns an empty set{ } to MLV which is a variable indicating leg vibration data stored in the table MLV of the database 5.

In the second line of the sample code, the minimum amplitude leg extractor 7 takes out window sizes w one by one in turn from a window size list W.

In the third line of the sample code, the minimum amplitude leg extractor 7 assigns values from 1 to w in turn to the time point t.

In the fourth and fifth lines of the sample code, the minimum amplitude leg extractor 7 calls “GetLongestLegSeq” shown in FIG. 11A, and thereby obtains a leg vibration sequence s with the amplitude “a” or more and the window size w.

In the sixth and seventh lines of the sample code, if the leg vibration sequence s is a minimum leg vibration sequence, the minimum amplitude leg extractor 7 adds, to the MLV, (t, a, F_{X,a,w}(t), w) which is leg vibration data on the minimum leg vibration sequence.

The minimum vibration number leg extractor 8 in the leg vibration data extractor 6 groups, into vibration number, pieces of leg vibration data having the same amplitude among the leg vibration data recorded in the table LV of the database 5. The minimum vibration number leg extractor 8 compares, for each group, respective window sizes of pieces of leg vibration data belonging to the group.

Subsequently, the minimum vibration number leg extractor 8 extracts, for each group, leg vibration data with the smallest window size from leg vibration data belonging to the group (one or more pieces of leg vibration data having the same vibration number) and records the extracted leg vibration data in the table MLV of the database 5 (step ST6 in FIG. 4).

The leg vibration data with the smallest window size with respect to vibration number is defined below. Namely, leg vibration data on a minimum leg vibration sequence s with respect to vibration number is defined.

[Leg Vibration Data with the Smallest Window Size with Respect to Vibration Number]

It is assumed that, when the amplitude is greater than or equal to a, a leg vibration sequence s satisfying the following formulas (29) and (30) is a minimum leg vibration sequence with respect to vibration number.

abs(F_{X,a,w}(t))>abs(F_{X,a,w-1}(t−1)) (29)

abs(F_{X,a,w}(t))>abs(F_{X,a,w-1}(t)) (30)

where t=start(s) and w=end(s)−start(s)+1

Accordingly, leg vibration data on the leg vibration sequence s satisfying the formulas (29) and (30) is leg vibration data with the smallest window size with respect to vibration number.

After the minimum amplitude leg extractor 7 and the minimum vibration number leg extractor 8 in the leg vibration data extractor 6 extract necessary leg vibration data from the table LV of the database 5 and record the extracted leg vibration data in the table MLV of the database 5, the leg vibration data retriever 9 retrieves leg vibration data satisfying a retrieval condition from the leg vibration data recorded in the table MLV of the database 5 (step ST7 in FIG. 4).

FIG. 8B is the table LV in the database 5, in which leg vibration data is recorded. It is assumed for convenience of description that, FIG. 8B is the table MLV of the database 5, in which leg vibration data extracted by the minimum amplitude leg extractor 7 and the minimum vibration number leg extractor 8 is recorded. In this case, when the retrieval condition is, for example, “vibration number=3”, leg vibration data with a start time of 101, the amplitude of 2.25 or more, and a window size of 153 is retrieved.

When the retrieval condition is “vibration number=−2”, leg vibration data with a start time of 227, the amplitude of 2.25 or more, and a window size of 27 is retrieved.

The example is presented here, in which the retrieval condition is the vibration number. However, the retrieval condition is not limited to the vibration number, and may be the start time, amplitude, or the window size.

In addition, there may be a plurality of retrieval conditions. Specifically, an AND condition of all or part of the start time, amplitude, vibration number, and window size may be used.

Note that the retrieval condition may be set beforehand in the leg vibration data retriever 9 or may be given by an external source.

After retrieving the leg vibration data satisfying the retrieval condition from the leg vibration data recorded in the table MLV of the database 5, the leg vibration data retriever 9 calculates a total number of appearances count(*) indicating the number of pieces of leg vibration data each of which has the same amplitude, the same vibration number, and the same window size among the retrieved one or more pieces of leg vibration data.

FIG. 9B shows an example of retrieval results obtained by the leg vibration data retriever 9.

In FIG. 9B, for example, one piece of leg vibration data with the amplitude of 4 or more and a window size of 267 is retrieved, and two pieces of leg vibration data with the amplitude of 3.75 or more and a window size of 299 are retrieved.

The example is presented here, in which the leg vibration data retriever 9 retrieves leg vibration data satisfying the retrieval condition from the leg vibration data recorded in the table MLV of the database 5. In circumstances where there is only a few pieces of leg vibration data having the same vibration number or only a few pieces of leg vibration data having the same amplitude, there is only a few pieces of redundant leg vibration data. In such cases, leg vibration data satisfying the retrieval condition may be retrieved from the leg vibration data recorded in the table LV in the database 5. By this, the leg vibration data extractor 6 becomes unnecessary, enabling to simplify the structure of the time-series-data processing device.

The visualizer 10 displays, as shown in FIG. 10 for example, amplitude, window sizes, and total numbers of appearances of the leg vibration data retrieved by the leg vibration data retriever 9 on a three-dimensional graph having the first axis for the amplitude, the second axis for the window size, and the third axis for the total number of appearances (step ST8 in FIG. 4).

As is clear from the above description, according to the Embodiment 1, it is configured to provide: the leg vibration sequence determinator 3 to determine, in time-series-data X, a leg vibration sequence being a leg series in which an upward leg and a downward leg extracted by the leg extractor 2 alternately appear, and calculate a vibration number indicating the number of legs forming the leg vibration sequence and a window size having a range from the start time point to end time point of the leg vibration sequence; and the database recorder 4 to record, as leg vibration data in the database 5, a set of an observation time at the start time point of the leg vibration sequence determined by the leg vibration sequence determinator 3, the amplitude of legs in the leg vibration sequence, and the vibration number and window size calculated by the leg vibration sequence determinator 3. Therefore, there is provided an advantageous effect that as information about a leg vibration sequence which is an important index in terms of detecting abnormalities in plant equipment, etc., leg vibration data can be accumulated.

This is capable of, for example, performing retrieval in which the start time point, window size, amplitude, and vibration number of leg vibration data are freely specified by using the existing SQL language, etc.

### Embodiment 2

In the above-described Embodiment 1, the minimum amplitude leg extractor 7 and the minimum vibration number leg extractor 8 in the leg vibration data extractor 6 extract necessary leg vibration data from leg vibration data recorded in the table LV of the database 5. Alternatively, the leg vibration data extractor 6 may include, in addition to the minimum amplitude leg extractor 7 and the minimum vibration number leg extractor 8, a maximum amplitude leg extractor 11 and a maximum vibration number leg extractor 12, which will be described later. In this configuration, the minimum amplitude leg extractor 7, the minimum vibration number leg extractor 8, the maximum amplitude leg extractor 11, and the maximum vibration number leg extractor 12 may extract necessary leg vibration data from leg vibration data recorded in the table LV of the database 5.

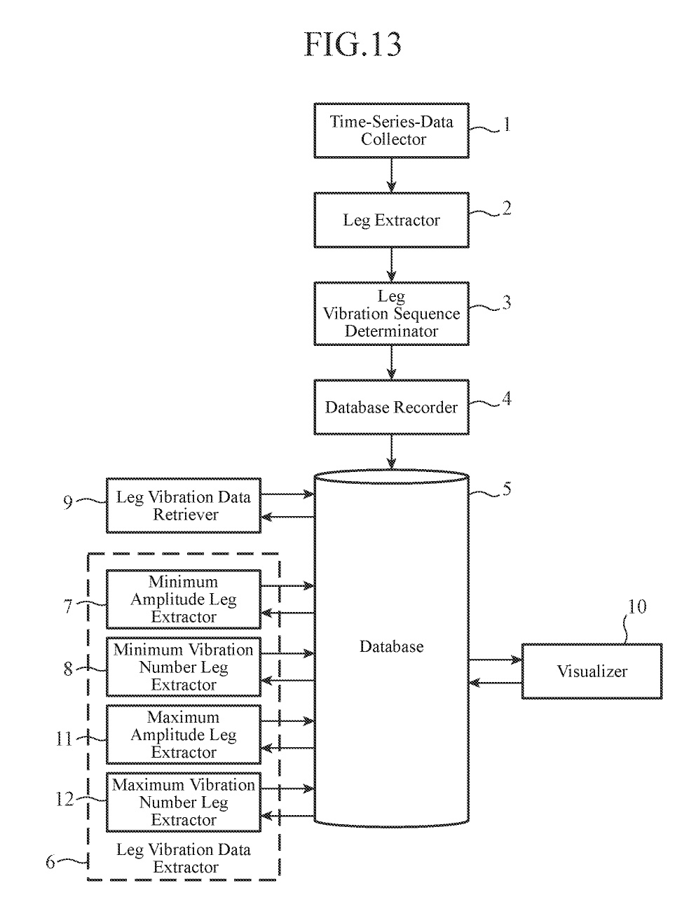

FIG. 13 is a structural diagram illustrating a time-series-data processing device of Embodiment 2 of the invention. In the drawing, the same reference signs as those of FIG. 1 indicate the same or corresponding portions and thus description thereof is omitted.

The maximum amplitude leg extractor 11 is implemented by, for example, the computing device 25. The maximum amplitude leg extractor 11 extracts, from leg vibration data recorded in the table LV of the database 5, one or more pieces of leg vibration data whose all or part of observation times are common with each other. In other words, one or more pieces of leg vibration data, each of which are present within a time range having a certain size, are extracted.

The maximum amplitude leg extractor 11 performs a process of comparing respective amplitude of the extracted one or more pieces of leg vibration data, extracting any one piece of leg vibration data, and recording the extracted leg vibration data in the table MLV of the database 5.

For example, respective amplitude of one or more pieces of leg vibration data, whose all or part of observation times are common with each other, are compared. After that, leg vibration data with the largest amplitude is extracted from the one or more pieces of leg vibration data, and the extracted leg vibration data is recorded in the table MLV of the database 5.

The maximum vibration number leg extractor 12 is implemented by, for example, the computing device 25. The maximum vibration number leg extractor 12 extracts, from the leg vibration data recorded in the table LV in the database 5, one or more pieces of leg vibration data whose all or part of observation times are common with each other. In other words, one or more pieces of leg vibration data, each of which are present within a time range having a certain size, are extracted.

The maximum vibration number leg extractor 12 performs a process of comparing respective vibration numbers of the extracted one or more pieces of leg vibration data, extracting any one piece of leg vibration data, and recording the extracted leg vibration data in the table MLV of the database 5.

For example, respective vibration numbers of one or more pieces of leg vibration data, whose all or part of observation times are common with each other, are compared. After that, leg vibration data with the largest vibration number are extracted from the one or more pieces of leg vibration data, and the extracted leg vibration data is recorded in the table MLV of the database 5.

In the example of FIG. 13, it is assumed that each of the time-series-data collector 1, the leg extractor 2, the leg vibration sequence determinator 3, the database recorder 4, the database 5, the leg vibration data extractor 6, the leg vibration data retriever 9, and the visualizer 10, which are components of the time-series-data processing device, is realized by dedicated hardware. Alternatively, the time-series-data processing device may be realized by a computer.

When the time-series-data processing device is realized by a computer, the database 5 may be formed in the memory 41 of the computer shown in FIG. 3, and a program that describes the processing contents of the time-series-data collector 1, the leg extractor 2, the leg vibration sequence determinator 3, the database recorder 4, the leg vibration data extractor 6, the leg vibration data retriever 9, and the visualizer 10 may be stored in the memory 41 of the computer. In this configuration, the processor 42 of the computer may execute the program stored in the memory 41.

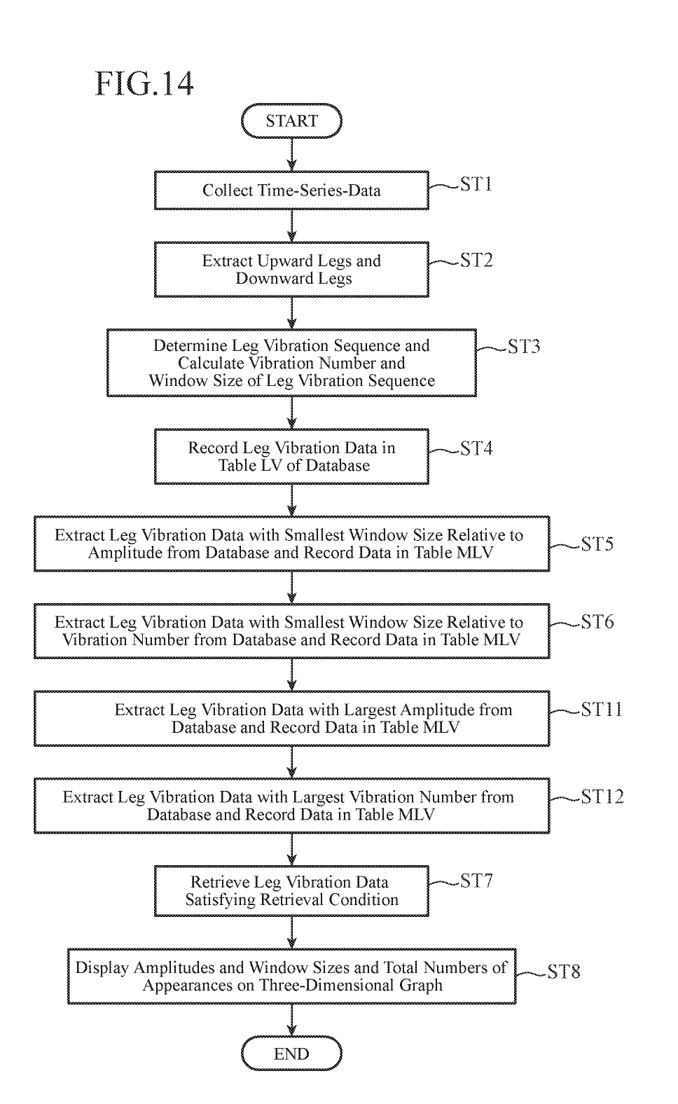

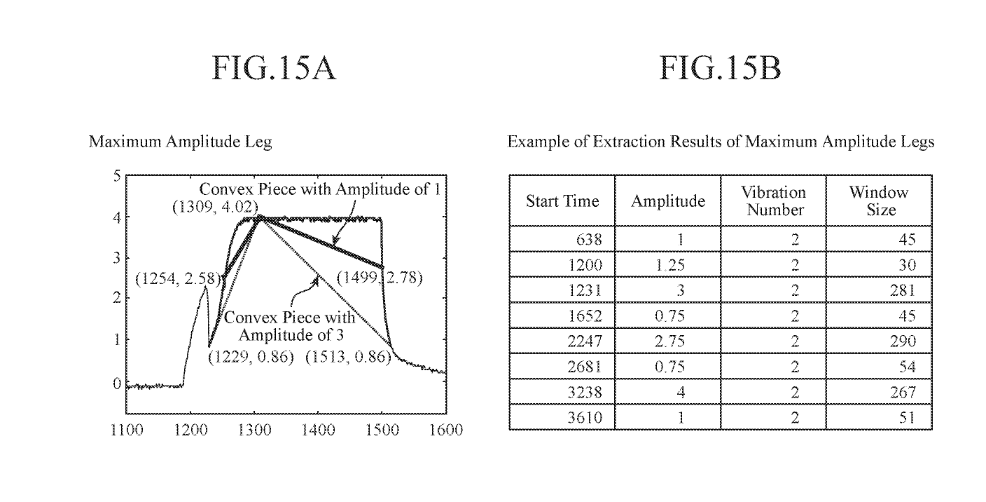

FIG. 14 is a flowchart representing the processing content of the time-series-data processing device of the Embodiment 2 of the invention.

FIGS. 15A and 15B are illustrative diagrams illustrating a process of extracting necessary leg vibration data, which is performed by the maximum amplitude leg extractor 11 of the leg vibration data extractor 6.

FIG. 15A shows a process of extracting one piece of leg vibration data to be recorded in the table MLV of the database 5 from among a plurality of pieces of leg vibration data whose all or part of observation times are common with each other, for instance, a plurality of pieces of leg vibration data present within an observation time range of around 1230 to 1520.

In the example of FIG. 15A, there are leg vibration data having a convex piece shaped pattern with the amplitude of 1 and leg vibration data having a convex piece shaped pattern with the amplitude of 3. Since the convex piece shaped pattern with the amplitude of 3 has larger amplitude than the convex piece shaped pattern with the amplitude of 1, it is determined that the convex piece shaped pattern with the amplitude of 3 is a maximum amplitude leg. Accordingly, the leg vibration data of the convex piece shaped pattern with the amplitude of 3 is extracted as leg vibration data to be recorded in the table MLV of the database 5.

In this case, the leg vibration data of the convex piece shaped pattern with the amplitude of 1, which is not determined as a maximum amplitude leg, is not recorded in the table MLV of the database 5.

FIG. 15B shows the results of extraction of maximum amplitude legs performed by the leg vibration data extractor 6.

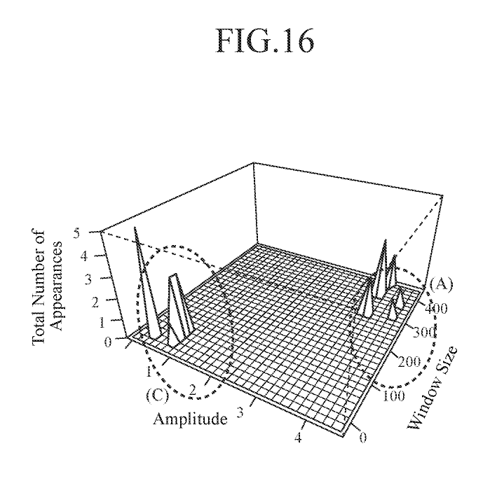

FIG. 16 is an illustrative diagram illustrating example visualization of maximum amplitude legs extracted by the leg vibration data extractor 6.

In the example of FIG. 16, the pattern of the portion (A) in FIG. 8A is clearly extracted.

Next, operation will be described.

The structure is the same as that of the above-described Embodiment 1 except that the maximum amplitude leg extractor 11 and the maximum vibration number leg extractor 12 are provided. Thus, the processing contents of the maximum amplitude leg extractor 11 and the maximum vibration number leg extractor 12 will be mainly described.

The maximum amplitude leg extractor 11 of the leg vibration data extractor 6 extracts, from leg vibration data recorded in the table LV in the database 5, one or more pieces of leg vibration data whose all or part of observation times are common with each other. Namely, one or more pieces of leg vibration data, which present within a time range having a certain size, are extracted.

After extracting one or more pieces of leg vibration data, the maximum amplitude leg extractor 11 compares respective amplitude of the extracted one or more pieces of leg vibration data.

In the example of FIG. 15A, two pieces of leg vibration data (the leg vibration data of a convex piece shaped pattern with the amplitude of 1 and the leg vibration data of a convex piece shaped pattern with the amplitude of 3) are present within the window size range of around 1230 to 1520. In this case, the respective amplitude of the two pieces of leg vibration data are compared with each other.

The maximum amplitude leg extractor 11 extracts leg vibration data with the largest amplitude from the one or more pieces of leg vibration data, whose all or part of observation times are common with each other, and records the extracted leg vibration data in the table MLV of the database 5 (step ST11 of FIG. 14).

In the example of FIG. 15A, it is determined that the convex piece shaped pattern with the amplitude of 3 is a maximum amplitude leg. Thus, the leg vibration data of the convex piece shaped pattern with the amplitude of 3 is extracted from the table LV of the database 5.

The maximum vibration number leg extractor 12 of the leg vibration data extractor 6 extracts, from the leg vibration data recorded in the table LV of the database 5, one or more pieces of leg vibration data whose all or part of observation times are common with each other. Namely, one or more pieces of leg vibration data, which are present within a time range having a certain size, are extracted.

After extracting one or more pieces of leg vibration data, the maximum vibration number leg extractor 12 compares the vibration numbers of the extracted one or more pieces of leg vibration data.

The maximum vibration number leg extractor 12 extracts leg vibration data with the largest vibration number from the one or more pieces of leg vibration data, whose all or part of observation times are common with each other, and records the extracted leg vibration data in the table MLV of the database 5 (step ST12 of FIG. 14).

After the minimum amplitude leg extractor 7, the minimum vibration number leg extractor 8, the maximum amplitude leg extractor 11, and the maximum vibration number leg extractor 12 of the leg vibration data extractor 6 extract necessary leg vibration data from the leg vibration data recorded in the table LV of the database 5 and record the extracted leg vibration data in the table MLV, the leg vibration data retriever 9 retrieves leg vibration data satisfying a retrieval condition from the leg vibration data recorded in the table MLV of the database 5 (step ST7 of FIG. 14).

The visualizer 10 displays, as shown in FIG. 16 for example, amplitude, window sizes, and total numbers of appearances of the leg vibration data retrieved by the leg vibration data retriever 9 on a three-dimensional graph having the first axis for the amplitude, the second axis for the window size, and the third axis for the total number of appearances (step ST8 of FIG. 14).

As is clear from the above, according to the Embodiment 2, it is configured to include the maximum amplitude leg extractor 11 to compare the amplitude of one or more pieces of leg vibration data, whose all or part of observation times are common with each other, from leg vibration data recorded in the table LV of the database 5, extract any one piece of leg vibration data from the one or more pieces of leg vibration data whose all or part of observation times are common with each other, and records the extracted data in the table MLV of the database 5. Thus, there is provided an advantageous effect that an important index in terms of detecting abnormalities in plant equipment, etc., can be displayed on a three-dimensional graph in an easy-to-understand manner.

In addition, it is configured to include the maximum vibration number leg extractor 12 to compare the vibration numbers of one or more pieces of leg vibration data, whose all or part of observation times are common with each other, from the leg vibration data recorded in the table LV in the database 5, extract any one piece of leg vibration data from the one or more pieces of leg vibration data whose all or part of observation times are common with each other, and record the extracted data in the table MLV of the database 5. Thus, there is provided an advantageous effect that an important index in terms of detecting abnormalities in plant equipment, etc., can be displayed on a three-dimensional graph in an easy-to-understand manner.

Note that free combinations of the embodiments, modifications to any component in the embodiments, or omissions of any component in the embodiments which fall within the spirit and scope of the invention of the present application may be made to the invention.

Time-series-data processing devices according to the invention are suitable for those that need to extract an index for detecting abnormalities in plant equipment, abnormalities in company management, etc., from time-series-data in which observed values at respective times are arranged.

1: Time-series-data collector, 2: Leg extractor, 3: Leg vibration sequence determinator, 4: Database recorder, 5: Database, 6: Leg vibration data extractor, 7: Minimum amplitude leg extractor, 8: Minimum vibration number leg extractor, 9: Leg vibration data retriever, 10: Visualizer, 11: Maximum amplitude leg extractor, 12: Maximum vibration number leg extractor, 21: Communication device, 22: Input/output device, 23: Main storage, 24: External storage, 25: Computing device, 26: Display device, 31 and 32: Upward leg, 33: Partial sequence, 33a: Observed value at a start time point, 33b: Observed value at an end time point, 33c: Observed values between the start time point and end time point, 34: Amplitude of the upward leg 31, 35: Amplitude of the upward leg 32, 41: Memory, and 42: Processor

1. A time-series-data processing device comprising:
a leg extractor (2) to extract an upward leg and a downward leg from time-series-data in which observed values at respective times are arranged, the upward leg being partial time series in which observed values indicating an upward trend with time passage are arranged, the downward leg being partial time series in which observed values indicating a downward trend with time passage are arranged;
a leg vibration sequence determinator (3) to determine a leg vibration sequence in the time-series-data and calculate a vibration number and a window size, the leg vibration sequence being a leg series in which the upward leg and the downward leg extracted by the leg extractor (2) alternately appear, the vibration number being a number of the legs forming the leg vibration sequence, the window size indicating a range from a start time point to an end time point of the leg vibration sequence;
a database recorder (4) to record, as leg vibration data in a database (5), a set of an observation time at the start time point of the leg vibration sequence determined by the leg vibration sequence determinator (3), amplitude of the legs in the leg vibration sequence, and the vibration number and the window size calculated by the leg vibration sequence determinator (3); and
a leg vibration data retriever (9) to retrieve leg vibration data satisfying a retrieval condition from the leg vibration data recorded in the database (5).

2. The time-series-data processing device according to claim 1, wherein the leg extractor (2) is configured to perform initial setup on the time-series-data to set a range where the upward leg and the downward leg are extracted, and is configured to extract upward legs and downward legs from the time-series-data while sliding the range.

3. The time-series-data processing device according to claim 1, wherein the leg vibration data retriever (9) is configured to calculate a total number of appearances being a number of pieces of leg vibration data, each of which has a same amplitude and a same vibration number and a same window size among the leg vibration data satisfying the retrieval condition.

4. The time-series-data processing device according to claim 3, further comprising a visualizer (10) to display amplitude and window sizes and total numbers of appearances in the leg vibration data retrieved by the leg vibration data retriever (9) on a three-dimensional graph having a first axis for the amplitude, a second axis for the window size, and a third axis for the total number of appearances.

5. The time-series-data processing device according to claim 1, further comprising
a leg vibration data extractor (6, 8) to
group pieces of the leg vibration data recorded in the database (5) into amplitude values, each of the grouped pieces having a same vibration number,
compare, for the grouped pieces of the leg vibration data, respective window sizes of the corresponding pieces, and
extract, for the grouped pieces of the leg vibration data, any one from among the corresponding pieces,
wherein the leg vibration data retriever (9) retrieves, from pieces of the leg vibration data extracted by the leg vibration data extractor (6, 8), a piece of the leg vibration data that satisfies the retrieval condition.

6. The time-series-data processing device according to claim 1, further comprising
a leg vibration data extractor (6, 7) to
group pieces of the leg vibration data recorded in the database (5) into vibration numbers, each of the grouped pieces having a same amplitude,
compare, for the grouped pieces of the leg vibration data, respective window sizes of the corresponding pieces, and
extract, for the grouped pieces of the leg vibration data, any one from among the corresponding pieces,
wherein the leg vibration data retriever (9) retrieves, from pieces of the leg vibration data extracted by the leg vibration data extractor (6, 7), a piece of the leg vibration data that satisfies the retrieval condition.

7. The time-series-data processing device according to claim 1, comprising
leg vibration data extractors (6, 7, 11) each of which is configured to
compare respective amplitude of one or more pieces of leg vibration data recorded in the database (5), whose all or part of observation times are common with each other, and
extract any one piece of the leg vibration data from among the one or more pieces of the leg vibration data, whose all or part of observation times are common with each other,
wherein the leg vibration data retriever (9) retrieves, from pieces of the leg vibration data extracted by the leg vibration data extractors (6, 7, 11), a piece of the leg vibration data that satisfies the retrieval condition.

8. The time-series-data processing device according to claim 1, comprising
leg vibration data extractors (6, 8, 12) each of which is configured to
compare respective vibration numbers of one or more pieces of leg vibration data recorded in the database (5), whose all or part of observation times are common with each other, and
extract any one piece of the leg vibration data from among the one or more pieces of the leg vibration data, whose all or part of observation times are common with each other,
wherein the leg vibration data retriever (9) retrieves, from pieces of the leg vibration data extracted by the leg vibration data extractors (6, 8, 12), a piece of the leg vibration data that satisfies the retrieval condition.
